(19) United States
(12) Patent Application Publication
(10) Pub. No.: US 2015/0110674 A1
(43) Pub. Date: Apr. 23, 2015

(54) COLORATION ANALYSIS DEVICE

(71) Applicant: FUJIFILM Corporation, Tokyo (JP)

(72) Inventor: Toshihito KIMURA, Ashigarakami-gun (JP)

(73) Assignee: FUJIFILM Corporation, Tokyo (JP)

(21) Appl. No.: 14/521,970

(22) Filed: Oct. 23, 2014

Related U.S. Application Data
(63) Continuation of application No. PCT/JP2013/061487, filed on Apr. 18, 2013.

(30) Foreign Application Priority Data
Apr. 24, 2012 (JP) 2012-098377

(51) Int. Cl. G01N 21/78; G01N 21/27; G01N 35/00; G01N 21/25

(52) U.S. Cl. CPC G01N 21/78; G01N 21/251; G01N 21/274; G01N 35/00693; G01N 2201/062
USPC 422/67; 422/82.09

(57) ABSTRACT

In a coloration analysis device that analyzes a coloration state in a coloration region of a dry analysis element in which a coloration region is formed which reacts with a test substance in a specimen solution and is colored, the effects of irradiation intensity unevenness of measuring light or light-receiving position sensitivity unevenness of a light-receiving optical system are eliminated, and it is possible to perform accurate analysis. A coloration region of the dry analysis element 12 and reference measurement plates 110 and 111 are irradiated with measuring light by a photometric head 96, reflected light from a measurement object is two-dimensionally detected as an image, and correction processing is performed for each pixel of an image of the coloration region, using corresponding pixel information of images of a black reference measurement plate 110 and a white reference measurement plate 111.

### CROSS-REFERENCE TO RELATED APPLICATIONS

This application is a Continuation of PCT International Application No. PCT/JP2013/061487 filed on Apr. 18, 2013, which claims priority under 35 U.S.C §119(a) to Japanese Patent Application No. 2012-098377 filed on Apr. 24, 2012. Each of the above applications is hereby expressly incorporated by reference, in its entirety, into the present application.

### BACKGROUND OF THE INVENTION

1. Field of the Invention

The present invention relates to a coloration analysis device that analyzes a coloration state in a coloration region of a dry analysis element in which a coloration region is formed which reacts with a test substance in a specimen solution and is colored.

2. Description of the Related Art

In recent years, various examinations have been performed by irradiating a measurement object with measuring light and detecting reflected light scattered by the measurement object. As an example, a colorimetric method of supplying droplets of a specimen as a spot to a dry analysis element and quantitatively analyzing a specific chemical component or material component contained in the specimen is performed.

In this colorimetric method, after the specimen is spotted on the dry analysis element, this dry analysis element is maintained at a constant temperature for a predetermined time within an incubator and is allowed to undergo a coloration reaction (coloring matter generation reaction). Next, the dry analysis element is irradiated with measuring light including a wavelength selected in advance according to the combination between a predetermined biochemical substance in the specimen and a reagent contained in the dry analysis element, and the optical density of light (hereinafter simply referred to as reflected light) scattered and reflected in the dry analysis element is measured, and the concentration of the biochemical substance is obtained from this optical density, using an analytical curve that is obtained in advance showing the correspondence between optical density and the substance concentration of the predetermined biochemical substance.

Additionally, in biochemical analysis devices (coloration analysis devices) that perform such a colorimetric method, in order to accurately measure the optical density of the reflected light, as illustrated in JP1988-106566A (JP-563-106566A), it is known that correction of photometric part may be performed using a white reference plate and a black reference plate in which reflection optical density is known.

### SUMMARY OF THE INVENTION

However, in the biochemical analysis device (coloration analysis device) that performs such a colorimetric method, if there is unevenness in an irradiation strength of measuring light in the coloration region or there is light-receiving position sensitivity unevenness in a light-receiving optical system when the reflected light in the coloration region is zero-dimensionally detected as illustrated in JP1987-247229A (JP-562-247229A), there is a problem in that a coloration state cannot be accurately measured even if the correction method described JP 1988-106566A (JP-563-106566A) is used.

Additionally, even if the reflected light in the coloration region is two-dimensionally detected as illustrated in JP2005-300528A, the effects of the irradiation intensity unevenness of the measuring light or the light-receiving position sensitivity unevenness of the light-receiving optical system cannot be eliminated in the correction method described in JP1988-106566A (JP-563-106566A) because correction is uniformly performed with respect to a detection region.

An object of the invention is to provide a coloration analysis device that analyzes a coloration state in a coloration region of a dry analysis element in which a coloration region is formed which reacts with a test substance in a specimen solution and is colored, thereby eliminating the effects of irradiation intensity unevenness of measuring light or light-receiving position sensitivity unevenness of a light-receiving optical system, and enabling accurate analysis to be performed.

The coloration analysis device of the invention is a coloration analysis device that analyzes a coloration state in a coloration region of a dry analysis element in which the coloration region is formed by laminating a supporting layer and a reaction layer where the coloration region reacts with a test substance in a specimen solution and is colored. The coloration analysis device includes a measuring light irradiation part for irradiating the dry analysis element or a reference measurement plate having a predetermined optical density with measuring light; an imaging part for receiving reflected light of the measuring light irradiated to the dry analysis element or the reference measurement plate, using light-receiving elements that are two-dimensionally arrayed, and for output of pixel signals indicating values of pixels that constitute an image showing the dry analysis element or the reference measurement plate; a control part for performing the control of making the imaging part perform imaging of the coloration region of the dry analysis element irradiated with the measuring light to acquire coloration pixel signals and for performing the control of making a first reference measurement plate, which is arranged at the same position as the position of the dry analysis element with respect to the measuring light irradiation part when the coloration pixel signals are acquired, be irradiated with the measuring light to make the imaging part perform imaging to acquire the first pixel signals; a correction part for performing correction processing for each pixel of the image of the coloration region represented by the coloration pixel signals, using values of pixels at the same positions on images, respectively, on the basis of the coloration pixel signals and the first pixel signals; and a computing part for quantitating the test substance, on the basis of the coloration pixel signals corrected by the correction part.

Here, the correction part may perform correction processing for each pixel of the image of the coloration region on the basis of Expression (1).

$$ODs = - Log ( \frac{{10}^{- ODw}}{ADw} \cdot ADs ) \qquad ( 1 )$$

Here,
ODs: Optical density at position corresponding to each pixel of detection image of coloration region,
ODw: Optical density at position corresponding to each pixel of detection image of reference measurement plate,
ADs: Signal value of each pixel of detection image of coloration region, and
ADw: Signal value of each pixel of detection image of reference measurement plate.

Additionally, the control part may make a second reference measurement plate, which has an optical density different from that of the first reference measurement plate and is arranged at the same position as the position of the dry analysis element with respect to the measuring light irradiation part when the coloration pixel signals are acquired, be irradiated with the measuring light to make the imaging part perform imaging to acquire second pixel signals, and the correction part may perform correction processing for each pixel of the image of the coloration region represented by the coloration pixel signals, using values of pixels at the same positions on images, respectively, on the basis of the coloration pixel signals, the first pixel signals, and the second pixel signals.

Here, the correction part may perform correction processing for each pixel of the image of the coloration region on the basis of Expression (2).

$$ODs = - Log ( \frac{{10}^{- ODw} - {10}^{- ODb}}{ADw - ADb} \cdot ( ADs - ADb ) + {10}^{- ODb} ) \qquad ( 2 )$$

Here,
ODs: Optical density at position corresponding to each pixel of detection image of coloration region,
ODb: Optical density at position corresponding to each pixel of detection image of reference measurement plate with higher optical density,
ODw: Optical density at position corresponding to each pixel of detection image of reference measurement plate with lower optical density,
ADs: Signal value of each pixel of detection image of coloration region,
ADb: Signal value of each pixel of detection image of reference measurement plate with higher optical density, and
ADw: Signal value of each pixel of detection image of reference measurement plate with lower optical density.

In addition, although the optical density to be assumed to be detected in the coloration region changes depending on the type of the coloration region, the optical density is approximately about 0.1 to about 2.0. Therefore, if the optical density of a reference measurement plate with a higher optical density out of the two reference measurement plates is set to 2.0 or more, and the optical density of a reference measurement plate with a lower optical density is set to 0.1 or less, it is possible to make the correction part of the coloration analysis device perform more accurate correction in all cases. However, there is a concern that provision a reference measurement plate with an extremely high optical density and a reference measurement plate with an extremely low optical density may lead to a cost rise. Accordingly, if the optical density of the reference measurement plate with a higher optical density out of the two reference measurement plates is set to 1.5 or more, and the optical density of the reference measurement plate with a lower optical density is set to 0.5 or less, it is possible to make the reading part of the coloration analysis device perform more accurate correction in most cases.

Additionally, the measuring light irradiation part may irradiate a predetermined irradiation region with the measuring light, and a movement part may be provided to move the dry analysis element and/or the reference measurement plate to the irradiation region.

Additionally, the light source of the measuring light irradiation part may be an LED.

According to the coloration analysis device related to the invention, since the reflected light in the coloration region is two-dimensionally detected as an image, an image of at least one reference measurement plate is acquired, and correction processing is performed for each pixel of the image of the coloration region, on the basis of the image of the reference measurement plate, the effect of irradiation intensity unevenness of the measuring light or light-receiving position sensitivity unevenness of the light-receiving optical system is eliminated, and it is possible to perform accurate analysis.

In this case, by performing correction processing for each pixel of the image of the coloration region on the basis of Expression (1), it is possible to perform more accurate correction processing.

Additionally, by acquiring the images of the two reference measurement plates to perform correction processing for each pixel of the image of the coloration region on the basis of the images of the two reference measurement plates, it is possible to perform more accurate correction processing.

In this case, by performing correction processing for each pixel of the image of the coloration region on the basis of Expression (2), it is possible to perform more accurate correction processing.

Additionally, by setting the optical density of the reference measurement plate with a higher optical density out of the two reference measurement plates to 1.5 or more and 2.0 or less and setting the optical density of the reference measurement plate with a lower optical density to 0.1 or more and 0.5 or less, it is possible to make the correction part of the biochemical analysis device perform accurate correction in most cases.

Additionally, if the measuring light irradiation part irradiates the predetermined irradiation region with the measuring light, and the movement part is provided to move the dry analysis element and/or the reference measurement plate to the irradiation region, the coloration analysis device of the invention can be realized with a simple configuration.

Additionally, in the coloration analysis device according to the invention, it is possible to eliminate the effects of the irradiation intensity unevenness of the measuring light or the light-receiving position sensitivity unevenness of the light-receiving optical system. Therefore, it is possible to use an LED in which unevenness is apt to occur as the light source of the measuring light irradiation part, and it is also possible to use a confocal optical system having light-receiving position sensitivity unevenness. Accordingly, cost reduction can be achieved by simplifying the configuration of the light source and a light-receiving system.

### BRIEF DESCRIPTION OF THE DRAWINGS

FIG. 1 is a partial cross-sectional front view illustrating a schematic configuration of a biochemical analysis device (coloration analysis device) that is an embodiment of the invention.

FIG. 2 is a plan view of a principal mechanism excluding a spotting mechanism at an element conveying position of the biochemical analysis device.

FIG. 3 is a cross-sectional front view of a conveying path portion of a dry analysis element of FIG. 1.

FIG. 4 is a cross-sectional front view of a photometric head of the biochemical analysis device.

FIG. 5 illustrates (a) an example of a detection image of a black reference measurement plate in the biochemical analysis device, illustrates (b) an example of a detection image of the coloration region, and illustrates (c) an example of a detection image of a white reference measurement plate.

FIG. 6 illustrates an example of an image of the coloration region after correction in the biochemical analysis device.

### DESCRIPTION OF THE PREFERRED EMBODIMENTS

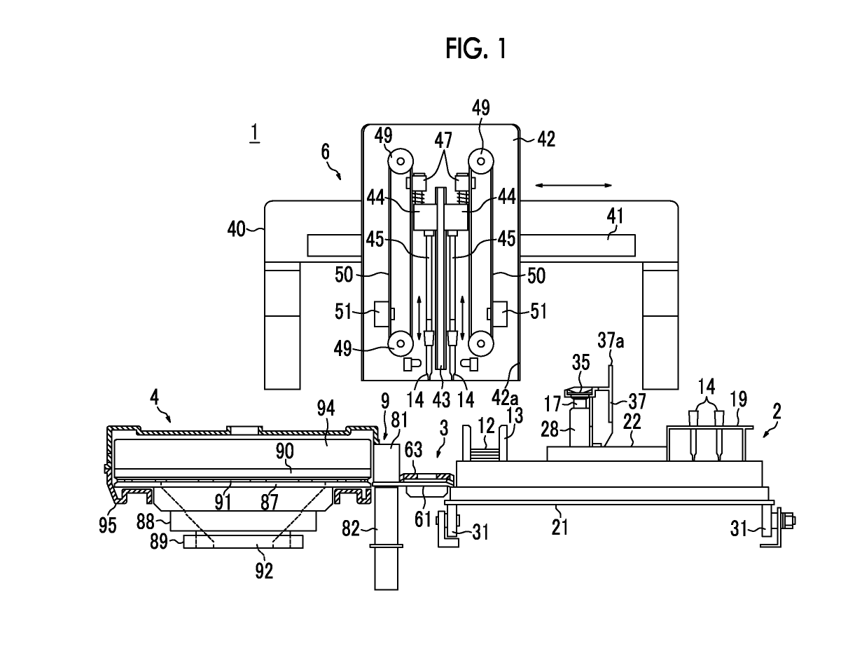

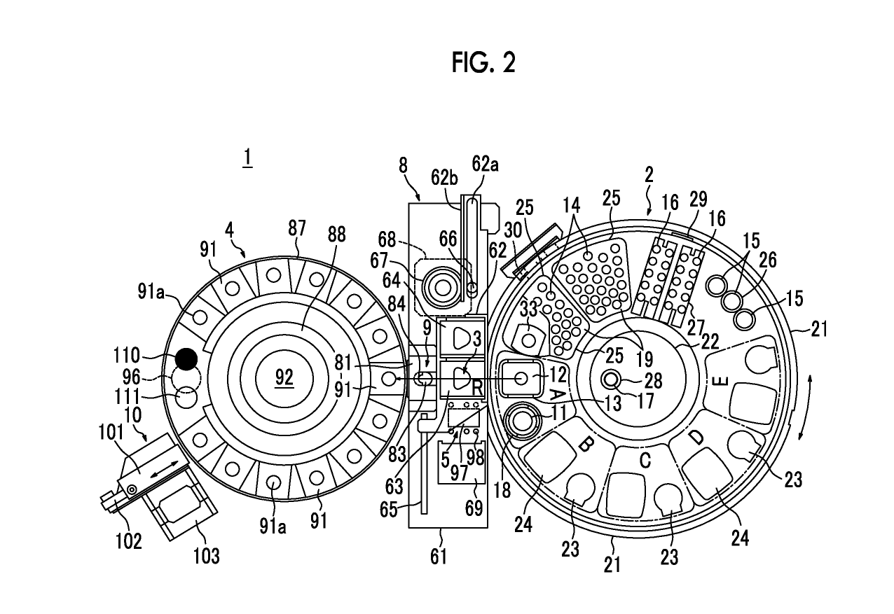

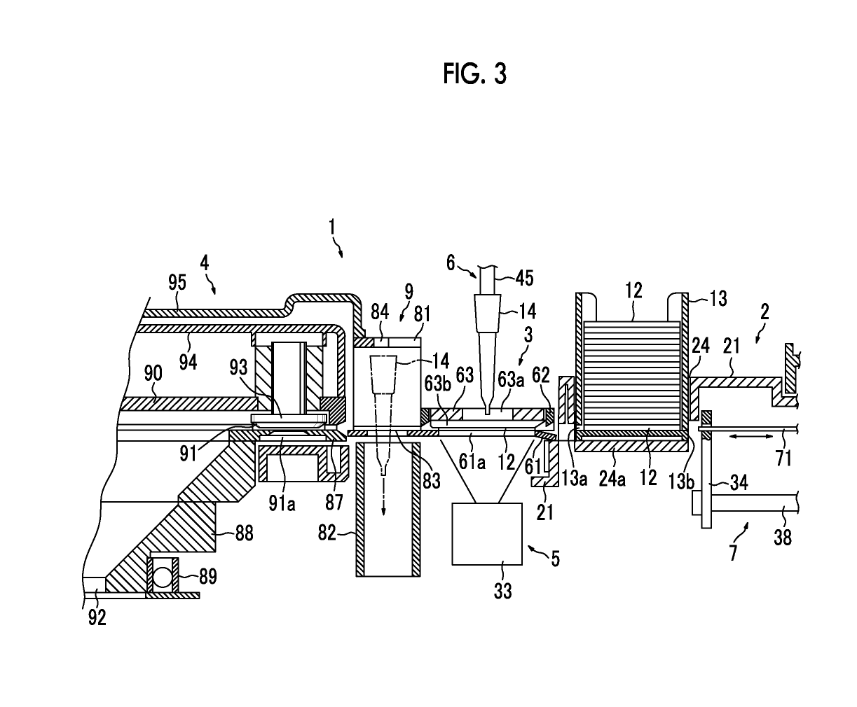

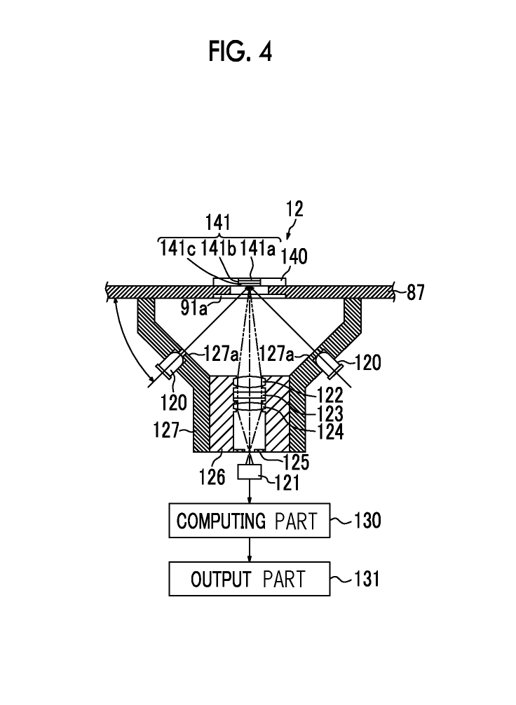

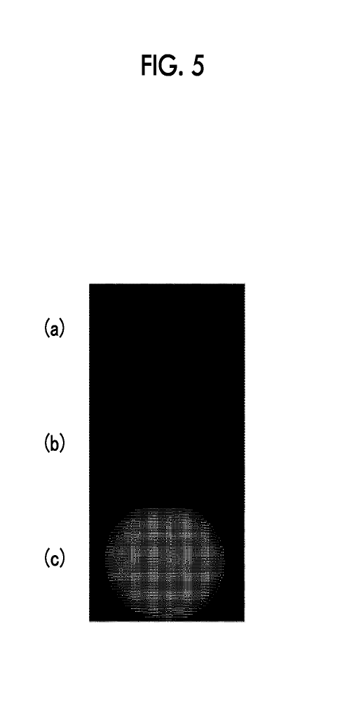

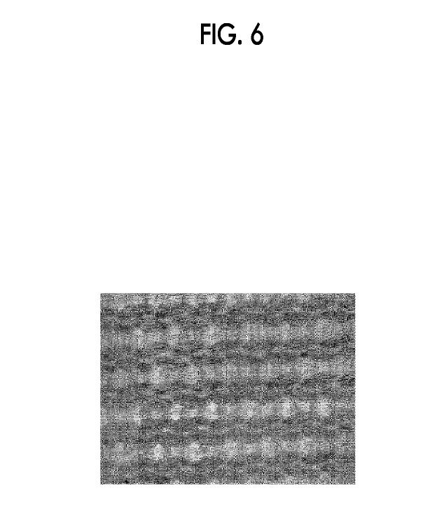

Hereinafter, a biochemical analysis device (coloration analysis device) that is an embodiment of the invention will be described with reference to the drawings. FIG. 1 is a partial cross-sectional front view illustrating a schematic configuration of the biochemical analysis device (coloration analysis device) that is the embodiment of the invention, FIG. 2 is a plan view of a principal mechanism excluding a spotting mechanism at an element conveying position of the biochemical analysis device, FIG. 3 is a cross-sectional front view of a conveying path portion of a dry analysis element of FIG. 1, FIG. 4 is a cross-sectional front view of a photometric head of the biochemical analysis device, FIG. 5 illustrates (a) an example of a detection image of a black reference measurement plate in the biochemical analysis device, illustrates (b) an example of a detection image of the coloration region, illustrates (c) an example of a detection image of a white reference measurement plate, and FIG. 6 illustrates an example of an image of the coloration region after correction in the biochemical analysis device.

An overall configuration of the biochemical analysis device 1 will be described with reference to FIGS. 1 to 4. A measuring mechanism of the biochemical analysis device 1 includes a specimen tray 2, a spotting unit 3, a first incubator 4, a second incubator 5, a spotting mechanism 6, an element conveying mechanism 7, a transfer mechanism 8, a tip discarding unit 9, the element discarding mechanism 10, a control unit that controls various mechanisms, and the like.

As illustrated in FIG. 2, the specimen tray 2 is circular, and is loaded with a specimen vessel 11 that contains a specimen, an element cartridge 13 that accommodates unused dry analysis elements 12 (a colorimetric type dry analysis element and an electrolyte type dry analysis element), and consumables (a nozzle tip 14, a diluting solution vessel 15, a mixing cup 16, and a reference solution vessel 17). In addition, the specimen vessel 11 is loaded via a specimen adapter 18, and a number of the nozzle tips 14 are housed in and loaded on a tip rack 19.

The spotting unit 3 is arranged on an extension of a centerline of the specimen tray 2, and spotting of specimens, such as plasma, whole blood, a blood serum, and urine, on the dry analysis elements 12 conveyed to the spotting unit is performed. The spotting mechanism 6 spots a specimen on the colorimetric type dry analysis element 12, and spots a specimen and a reference solution on the electrolyte type dry analysis element 12. The tip discarding unit 9 on which the nozzle tips 14 are discarded is arranged to follow the spotting unit 3.

The first incubator 4 is circular, is arranged at an extended position of the tip discarding unit 9, accommodates the colorimetric type dry analysis element 12, maintains the colorimetric type dry analysis element at a constant temperature for a predetermined time, and performs colorimetry. The second incubator 5 (refer to FIG. 2) is arranged at a position laterally adjoining the spotting unit 3, accommodates the electrolyte type dry analysis element 12, maintains the dry analysis element at a constant temperature for a predetermined time, and performs potentiometry.

Although not illustrated in detail, the element conveying mechanism 7 (refer to FIG. 3) includes an element conveying member 71 (conveying bar) that is arranged inside the specimen tray 2, connects the center of the specimen tray 2 with the center of the first incubator 4, and conveys the dry analysis elements 12 from the specimen tray 2 to the spotting unit 3 and further to the first incubator 4, along a linear element conveying path R (FIG. 2) passing through the spotting unit 3 and the tip discarding unit 9. The element conveying member 71 is slidably supported by a guide rod 38 and is reciprocally operated by a driving mechanism (not illustrated), and a tip portion thereof is inserted into a guide hole 34a of a vertical plate 34, and slides along the guide hole 34a.

The transfer mechanism 8 is installed to serve also as the spotting unit 3, and transfers the electrolyte type dry analysis element 12 in a direction orthogonal to the element conveying path R from the spotting unit 3 to the second incubator 5.

The spotting mechanism 6 is arranged at an upper portion, and a spotting nozzle 45 that moves up and down on the same straight line as the aforementioned element conveying path R and performs spotting of a specimen and a reference solution and diluting of the specimen by a diluting solution and mixing. The spotting nozzle 45 has a nozzle tip 14 mounted on a tip thereof, and suctions and discharges a specimen, a reference solution, or the like into (from) the nozzle tip 14. A syringe part (not illustrated) that performs the suction and the discharge is attached to the spotting nozzle, and the nozzle tip 14 after use is removed, dropped, and discarded in the tip discarding unit 9.

The element discarding mechanism 10 (refer to FIG. 2) is attached to the first incubator 4, and pushes out, drops, and discards the colorimetric type dry analysis element 12 after measurement to a central portion of the first incubator 4. In addition, the colorimetric type dry analysis element can also be discarded by the element conveying mechanism 7. Additionally, the electrolyte type dry analysis element 12 after measurement in the second incubator 5 is discarded in a discarding hole 69 by the transfer mechanism 8.

Additionally, a blood filtration unit (not illustrated) that separates plasma from blood is installed in the vicinity of the specimen tray 2.

The mechanisms of the above respective units will be specifically described below. First, the specimen tray 2 has a disk-like rotary disk 21 that is rotationally driven in a normal direction and a reverse direction, and a disk-like non-rotating portion 22 at a central portion.

As illustrated in FIG. 2, five (A to E) specimen loading portions 23 each of which holds a specimen vessel 11, such as a blood collection tube, which contains each specimen, via the specimen adapter 18, five element loading portions 24 which are adjacent to the specimen loading portions, respectively, and each of which holds the element cartridge 13 that accommodates a plurality of types of the unused dry analysis elements 12, which are usually required corresponding to measurement items of each specimen, in a stacked state, two tip loading portions 25 each of which holds the tip rack 19 that accommodates a number of the nozzle tips 14 side by side in holding holes, a diluting solution loading portion 26 that holds three diluting solution vessels 15 each of which accommodates a diluting solution, and a cup loading portion 27 that holds the mixing cups 16 (molded products in which a number of cup-like recesses are arranged) for mixing a diluting solution and a specimen are arranged in a circular-arc shape on the rotary disk 21.

Additionally, a tubular reference solution loading portion 28 that holds the reference solution vessel 17 that contains a reference solution is provided within a movement range of the spotting nozzle 45 on the extension of the element conveying path R in the non-rotating portion 22, and an evaporation preventing lid 35 (FIG. 1) that opens and closes the opening of the reference solution vessel 17 is installed in the reference solution loading portion 28.

The evaporation preventing lid 35 has a lower end held by a rocking member 37 that is rockably pivoted on the non-rotating portion 22, and is biased in a closing direction. An upper end locking portion 37a of the rocking member 37 is enabled to abut against a lower end corner 42a of a movable frame 42 of the spotting mechanism 6, and the rocking member 37 is rocked in an opening direction by the movable frame 42 that has moved close thereto when a reference solution is suctioned, and the evaporation preventing lid 35 opens the reference solution vessel 17 to allow the reference solution to be suctioned by the spotting nozzle 45. In the other states, the evaporation preventing lid 35 blocks the opening of the reference solution vessel 17 to prevent the evaporation of the reference solution, and the degradation of measurement precision by a change in the concentration of the reference solution is prevented.

The rotary disk 21 has an outer peripheral portion supported by supporting rollers 31 and has a central portion rotatably held by a supporting shaft (not illustrated). Additionally, a timing belt (not illustrated) is wound around an outer periphery of the rotary disk 21, and is rotationally driven in a normal direction or a reverse direction by a drive motor. The non-rotating portion 22 is non-rotatably attached to the supporting shaft.

As illustrated in FIG. 3, a plurality of the unused dry analysis elements 12 are usually stacked and inserted into the element cartridge 13 from above in a mixed state. If the element cartridge is loaded into an element loading portion 24, a lower end thereof is held by a bottom wall 24a of the element loading portion 24, and a dry analysis element 12 at the lowest end is located at the same height as an element conveying surface, an opening 13a for allowing only one dry analysis element 12 to pass therethrough is formed on a front surface side of a lowest end of the element cartridge, and an opening 13b for allowing the element conveying member 71 to be inserted therethrough is formed on a back surface side of the lowest end.

Additionally, a window portion 13c is formed in a bottom surface of the element cartridge 13 and a window portion 24b is also formed in the bottom wall 24a of the element loading portion 24 so that element information given to a lower surface of a dry analysis element 12 can be read from below the element cartridge 13.

A reader 33 that reads element information given by a dot array pattern (not illustrated) of a dry analysis element 12 is installed below the specimen tray 2. The reader 33 is installed below a position to which the element cartridge 13 (element loading portion 24) accommodating a dry analysis element 12 used for measurement of a specimen has moved when the rotary disk 21 has been rotated by the actuation of the specimen tray 2 from the element conveying position illustrated in FIG. 3 and a specimen vessel 11 (specimen loading portion 23) has moved to a suction position on a movement path (element conveying path R) of the spotting nozzle 45 as illustrated in FIG. 3. That is, in the illustrated case, the reader 33 is installed at the rotational position of the element loading portion 24 with a phase angle shifted from the element conveying path R by a phase pitch between the specimen loading portion 23 and the element loading portion 24. In addition, the reader 33 with the rotary disk 21 being partially cut away is illustrated in FIG. 3, and the reader 33 is illustrated below the element loading portion 24 on the element conveying path R for convenience in FIG. 3.

The reader 33 is constituted by a CCD camera corresponding to a dot recording type. The reading of the element information on a dry analysis element 12 by the reader 33 is performed ahead of the specimen suction from a corresponding specimen vessel 11 and the conveyance of the dry analysis element 12. Reagent type information, reagent lot information, information required to measure optical density, and information required in order to calculate concentration from optical density, and the like, which are related to the dry analysis element 12, can be obtained by the reader 33, and the front and the back and a front-back direction can be further recognized from a recording pattern or the like. Accordingly, poor setting can be detected, and it is possible to emit a warning.

Additionally, the specimen adapter 18 is formed in the shape of a tube, and has a specimen vessel 11 inserted thereinto from an upper portion. The specimen adapter 18 has an identification unit (not illustrated), information on the type of a specimen (processing information), the type (size) of a specimen vessel 11, and the like are set, the identification information is read by the identification sensor 30 (FIG. 2) arranged at an outer peripheral portion of the specimen tray 2 at an initial time point of measurement, the presence/absence of dilution of the specimen, the presence/absence of plasma filtration, and the like are discriminated, the amount of liquid level fluctuation accompanying the size of the specimen vessel 11 is calculated, and processing control according to the fluctuation amount is performed. A holder including a filtration filter is mounted on the specimen vessel 11 where plasma filtration is required, via spacers (all are not illustrated), after the specimen vessel 11 is inserted into the adapter 18.

The spotting unit 3 and the transfer mechanism 8 include an elongated supporting base 61 in the direction orthogonal to the element conveying path R between the specimen tray 2 and the first incubator 4, and a sliding frame 62 is movably installed on the supporting base. A first element presser 63 in which a spotting opening 63a (FIG. 3) is formed and a second element presser 64 are integrally movably mounted on the sliding frame 62 adjacent to each other. The first element presser 63 (the same also applies to the second element presser 64) has a recess 63b through which a dry analysis element 12 passes along the element conveying path R, in a bottom surface facing the supporting base 61. Additionally, the sliding frame 62 has one end guided by a guide bar 65 and has a pin 66 engaged with an elongated groove 62a at the other end thereof, and a driving gear 67 of the drive motor 68 is moved in meshing with a rack gear 62b. The second incubator 5 and the discarding hole 69 are installed in the supporting base 61.

As illustrated in FIG. 2, when the first element presser 63 is located at the spotting unit 3, a colorimetric type dry analysis element 12 after spotting is pushed out by the element conveying mechanism and is transferred to the first incubator 4. Meanwhile, if spotting to the electrolyte type dry analysis element 12 is performed, the sliding frame 62 is moved, the dry analysis element 12 after the spotting is transferred to the second incubator 5 so as to slide on the supporting base 61 while being held by the first element presser 63, and potentiometry is performed in the second incubator. In that case, the second element presser 64 is moved to the spotting unit 3 (spotting position), and the spotting of a specimen to a colorimetric type dry analysis element 12 to be conveyed after the movement, and the conveyance of the specimen to the first incubator 4 are enabled. If the measurement in the second incubator 5 is completed, the sliding frame 62 is further moved, and a dry analysis element 12 after the measurement is transferred, dropped, and discarded in the discarding hole 69.

In addition, the second element presser 64 may be moved to the spotting unit 3 when the colorimetric type dry analysis element 12 is conveyed, and the first element presser 63 may be moved to the spotting unit 3 only when the electrolyte type dry analysis element 12 is conveyed.

Additionally, the reader 33 performs reading of information other than the reading of the dot array pattern. Therefore, an additional light source (not illustrated) is installed. As the additional light source, a light source having a specific wavelength, such as a light source for infrared rays or a light source for degradation detection, is installed in accordance with a detection aspect. Spotting information obtained by this information reader and the other reading will be described below.

The spotting mechanism 6 (FIG. 1) includes a movable frame 42 held by a horizontal guide rail 41 of a fixed frame 40 so as to be movable in a lateral direction, and two spotting nozzles 45 are installed on the movable frame 42 so as to be movable up and down. A vertical guide rail 43 is anchored to the center of the movable frame 42, and two nozzle fixing bases 44 are slidably held on both sides of the vertical guide rail 43. Upper ends of the spotting nozzles 45 are anchored to lower portions of the nozzle fixing bases 44, respectively, and shaft-shaped members extending upward are inserted through driving transmission members 47 at upper portions of the nozzle fixing bases. A fitting force of the nozzle tip 14 is obtained by a compression spring interposed between the nozzle fixing base 44 and the driving transmission member 47. The nozzle fixing base 44 is movable vertically and integrally with the driving transmission member 47, and when the nozzle tip 14 is fitted to a tip portion of the spotting nozzle 45, the nozzle fixing base 44 is movable downward with respect to the driving transmission member 47 by the compression of the compression spring. The driving transmission member 47 is fixed to a belt 50 stretched over upper and lower pulleys 49, and vertically moves in accordance with the traveling of the belt 50 by a motor (not illustrated). In addition, a balance weight 51 is attached to an outside portion of the belt 50, and downward movement of the spotting nozzle 45 during non-driving is prevented.

Additionally, the movable frame 42 is driven in the lateral direction by a belt driving mechanism (not illustrated), the two nozzle fixing bases 44 are controlled in horizontal movement and vertical movement so as to move vertically and independently, and the two spotting nozzles 45 move laterally and integrally and move independently and vertically. For example, one spotting nozzle 45 is used for a specimen, and the other spotting nozzle 45 is used for a diluting solution and a reference solution.

Both the spotting nozzles 45 are formed in the shape of a rod, an air passage that extends in an axial direction is provided inside each of the spotting nozzles, and a pipette-like nozzle tip 14 is fitted to a lower end of the spotting nozzle in a sealed state. An air tube connected to a syringe pump (not illustrated) or the like is coupled to each of the spotting nozzles 45, and suction and discharge pressure are supplied through the air tube. Additionally, liquid level detection of a specimen or the like can be performed on the basis of a change in this suction pressure.

The tip discarding unit 9 is provided to intersect the conveying path R in the vertical direction, and includes an upper member 81 and a lower member 82. The supporting base 61 in the tip discarding unit 9 is formed with a drop port 83 that opens in an elliptical shape. The upper member 81 is anchored to an upper surface of the supporting base 61, an engaging cutout 84 is provided at a portion right above the drop port 83, the lower member 82 is formed in the shape of a tube in a lower surface of the supporting base 61 so as to surround the lower side of the drop port 83, and is adapted so as to guide a dropping nozzle tip 14.

The spotting nozzle 45 on which the nozzle tip 14 is mounted is moved in the lateral direction after being dropped into the upper member 81, the spotting nozzle 45 is moved up and the nozzle tip 14 is extracted after an upper end of the nozzle tip 14 is engaged with the engaging cutout 84, and the removed nozzle tip 14 is dropped and discarded through the drop port 83.

The first incubator 4 that performs colorimetry has an annular rotating member (a movement part) 87 at an outer peripheral portion thereof, and an inclined rotating cylinder 88 anchored to an inner peripheral lower portion of the rotating member 87 is rotatably supported by a lower bearing 89. An upper member 90 is integrally and rotatably arranged at an upper portion of the rotating member 87. A bottom surface of the upper member 90 is flat, a plurality of recesses (thirteen in the case of FIG. 2) are formed at predetermined intervals on the circumference in an upper surface of the rotating member 87, element chambers 91 formed by slit-like spaces are formed between both of the members 87 and 90, and the height of the bottom surface of each element chamber 91 is made equal to the height of the conveying surface. Additionally, an inner hole of the inclined rotating cylinder 88 is formed in a discarding hole 92 for a dry analysis element 12 after measurement, and a dry analysis element 12 in an element chamber 91 is moved, dropped, and discarded to a center side as it is. In addition, only the arrangement of the element chambers 91 on the rotating member 87 is illustrated in FIG. 2.

Additionally, a black reference measurement plate 110 and a white reference measurement plate 111 are integrally and rotatably arranged at the upper portion of the rotating member 87. The optical density of the black reference measurement plate is set to a known value of 1.5 or more in advance, and the optical density of the white reference measurement plate is set to a known value of 0.5 or less in advance. In addition, opening windows (not illustrated) are formed under the black reference measurement plate 110 and the white reference measurement plate 111, respectively, and measurement of reflection optical density by a photometric head 96 arranged at a position illustrated in FIG. 2 is performed through these opening windows.

A heating part (not illustrated) is arranged at the upper member 90, and a dry analysis element 12 within an element chamber 91 is maintained at a predetermined constant temperature by the temperature control of the heating part. Moreover, as illustrated in FIG. 3, a pressing member 93 that presses down a mount for a dry analysis element 12 corresponding to an element chamber 91 from above and prevents evaporation of a specimen is discarded at the upper member 90. A heat-retaining cover 94 is arranged on an upper surface of the upper member 90, while the whole first incubator 4 is covered with a light-shielding cover 95. Moreover, a photometric opening window 91a is formed at the center of a bottom surface of each element chamber 91 of the rotating member 87, and the reflection optical density of a dry analysis element 12 by the photometric head 96 arranged at the position illustrated in FIG. 2 is measured through the opening window 91a. The first incubator 4 is rotationally driven by a belt mechanism (not illustrated), and is reciprocally and rotationally driven.

In the colorimetric type dry analysis element 12, as illustrated in FIG. 4, a coloration region 141 is formed at a portion of a substrate 140 formed of resin or the like. In the coloration region 141, a reaction layer 141b is laminated by application, adhesion, or the like on a light-transmissive supporting layer 141c made of a plastic sheet, such as an organic polymer sheet of polyethylene terephthalate (PET), polystyrene, or the like, and a development layer 141a is further laminated on the supporting layer by a laminating method or the like.

As illustrated in FIG. 4, the photometric head 96 is constituted by an LED (a measuring light irradiation part) 120 that is a light source for irradiating measuring light to the black reference measurement plate 110, the white reference measurement plate 111, or the coloration region 141, an imaging element (an imaging part) 121 that performs photoelectric conversion of received light, focusing lenses 122 and 124 that focus light on the imaging element 121, an IR cut-off filter 123 that cuts off infrared light that is emitted from the LED 120 and is unnecessary for measurement, and a lens holder 126 that holds the focusing lenses 122 and 124 and the IR cut-off filter 123. By arranging an aperture 125 at a position where light is condensed by the focusing lens 124, a so-called “confocal optical system” can be formed, and light can be cut from regions other than a predetermined region that is used for measurement. The LED 120 and the lens holder 126 are held by a lens barrel 127.

In addition, the LED is not limited to a shell type LED in which protective resin as illustrated in FIG. 4 functions as a lens, and arbitrary types of LED, such as a surface-mount type LED without any lens, may be used. However, since the shell type LED generally has a greater irradiation intensity unevenness but has a greater quantity of irradiation light per unit area, the shell type LED is apt to receive the benefit of the invention.

Additionally, since there are dry analysis elements having various coloration reaction spectra depending on objects to be detected, it is general that general-purpose devices include a plurality of LEDs having different wavelengths, such as 400 nm, 415 nm, 505 nm, 540 nm, 577 nm, 600 nm, 625 nm, 650 nm, and the like. In this case, an LED having a predetermined wavelength determined on the basis of information obtained from the reader 33 is turned on. Additionally, although a case where high-output LEDs are not available depending on wavelengths is considered, the output may be improved using a plurality of LEDs having the same wavelength in that case.

A computing part 130 has a function as a correction part for performing correction processing, using corresponding pixel information of images of the two reference measurement plates for each pixel of an image of the coloration region 141, and also has a function of quantitating a test substance, on the basis of a corrected coloration pixel signal. The results of processing in the computing part 130 are output to an output part 131, such as a monitor or a printer.

The discarding mechanism 10 includes a discarding bar 101 that advances and retreats into/from an element chamber 91 in a direction toward a center from the outer peripheral side. The discarding bar 101 has a rear end fixed to the belt 102 that travels in the horizontal direction, and pushes out and discards a dry analysis element 12 after measurement from an element chamber 91 in accordance with the traveling of the belt 102 by the driving of the drive motor 103. In addition, a collection box that collects the dry analysis element 12 after measurement is arranged below the discarding hole 92.

Additionally, in the second incubator 5 that measures ionic activity, the first element presser 63 of the sliding frame 62 serves as an upper member, and, one element chamber is formed between the first element presser and an upper surface of a measurement body 97 by a recess at the bottom of the first element presser. A heating part (not illustrated) is arranged at the second incubator 5, and a portion that measures the ionic activity of a dry analysis element 12 is heated to a predetermined constant temperature by the temperature control of the heating part. Moreover, three pairs of potentiometric probes 98 for measurement of ionic activity are provided at lateral edges of the measurement body 97 so as to be capable of protruding or retracting and coming into contact with an ion-selective electrode of a dry analysis element 12.

In addition, a plasma filtration unit (not illustrated) separates and suctions plasma from blood via a holder (not illustrated) having a filter that is inserted into a specimen vessel 11 (blood collection tube) held by the specimen tray 2 and is made of glass fibers attached to an upper end opening, and holds the filtered plasma in a cup portion of an upper end of the holder.

The operation, setting of measurement conditions, and the like in the biochemical analysis devices 1 as described above are performed by the input from a control panel (not illustrated) installed in a housing (not illustrated). The control panel is connected to a control unit (a control part) that is not illustrated. In this control panel, measurement computation processing based on a control program registered in the control panel is set, and an automatic measurement operation, a manual measurement operation, an urgent measurement operation, a calibration (correction) operation, a printing operation, and the like are selectively executed.

Next, the overall operation of the aforementioned biochemical analysis device 1 will be described. First, before analysis is performed, measurement preparation is performed by loading the loading portions 23 to 28 of the specimen tray 2 with a specimen vessel 11 that contains each specimen, the element cartridge 13 loaded with the dry analysis elements 12, the tip rack 19 that holds the nozzle tips 14, the mixing cups 16, the diluting solution vessels 15, and the reference solution vessel 17, respectively.

Thereafter, analysis processing is started. First, in the case of a specimen that requires plasma filtration, the whole blood within the specimen vessel 11 is filtered by the blood filtration unit to obtain a plasma component. Next, the rotary disk 21 is rotated to stop the element cartridge 13 for the specimen to be measured, at an element extraction position corresponding to the spotting unit 3, and a dry analysis element 12 is taken out from the element cartridge 13 by the element conveying mechanism and conveyed to the spotting unit 3. In addition, before being conveyed to the spotting unit 3, analysis information given to the dry analysis element 12 is read, and the subsequent operation is controlled.

Then, when measurement items are colorimetric, the dry analysis element 12 is conveyed in a state where the element presser 64 is located at the spotting unit, and subsequently, the specimen tray 2 is rotated to move a nozzle tip 14 of the tip rack 19 to below a spotting nozzle 45, and is mounted on the spotting nozzle 45. Subsequently, the specimen vessel 11 is moved, the spotting nozzle 45 is moved down to suction the specimen to the nozzle tip 14, the spotting nozzle 45 is moved to the spotting unit 3, and the specimen is spotted on the dry analysis element 12.

Then, the colorimetric type dry analysis element 12 on which the specimen is spotted is inserted into the first incubator 4. Next, the element chambers 91 are rotated and maintained at a constant temperature for a predetermined time. Thereafter, the inserted dry analysis element 12 is sequentially moved to the position of the photometric head 96, and the reflection optical density of the dry analysis element 12 is measured.

The reflected light scattered and reflected in the coloration region 141 of the dry analysis element 12 at the time of measurement carries optical information (specifically quantity of light) according to the amount of coloring matter generated in the reaction layer 141b, and the reflected light carrying this optical information is detected by the imaging element 121, and a detection image of the coloration region 141 as illustrated in FIG. 5(b) is acquired.

Additionally, the measurement of the reflection optical density is also performed with respect to the black reference measurement plate 110 and the white reference measurement plate 111 having known different optical densities by the photometric head 96, and detection images of the black reference measurement plate 110 and the white reference measurement plate 111 as illustrated in FIGS. 5(a) and 5(c) are acquired in the computing part 130. In addition, when the illumination wavelength of the LED is changed according to the types of the dry analysis element 12 as being earlier described, it is also necessary to perform the measurement of the black reference measurement plate 110 and the measurement of the white reference measurement plate 111, respectively, for each wavelength.

In addition, although timings at which the detection images of the black reference measurement plate 110 and the white reference measurement plate 111 are acquired may be at arbitrary timings, such that the timings are measured before a device is shipped, are measured when the photometric head 96 is measured, the timings are acquired whenever measurement is performed with respect to the dry analysis elements 12, the timings are acquired at the time of starting of the device, or the timings are acquired at predetermined time intervals, it is desirable in any case to use the newest images of the reference measurement plates for computation to be described below for the purpose of reflecting the present state.

The computing part 130 performs correction processing, using corresponding pixel information of the detection images of the black reference measurement plate 110 and the white reference measurement plate 111, for each of pixels showing the image of the coloration region 141, on the basis of Expression (2). Here, the corresponding pixels are pixels in which the relationships between a striking spot of the measuring light and an imaging position are the same, in the pixels showing the image of the coloration region 141, the pixels showing the image of the black reference measurement plate 110, or the pixels showing the image of the white reference measurement plate 111. In the present embodiment, the coloration region 141, the black reference measurement plate 110, and the white reference measurement plate 111 are imaged at the same position with respect to the photometric head 96 having the LED 120 and the imaging element 121 by rotating the element chambers 91. In this case, the corresponding pixels in the pixels showing the respective images are pixels at the same positions on the images, that is, pixels at the same positions on the imaging element 121. The image of the coloration region 141 after correction without the effects of irradiation intensity unevenness of the measuring light or light-receiving position sensitivity unevenness of the light-receiving optical system as illustrated in FIG. 6 can be acquired as a result of such correction processing. In addition, if the relationships between a striking spot of the measuring light and an imaging position are the same, the photometric head 96 does not need to be fixed and perform imaging. For example, imaging may be performed by fixing the position of the coloration region 141, the black reference measurement plate 110, or the white reference measurement plate 111 and moving the position of the photometric head 96.

$$ODs = - Log ( \frac{{10}^{- ODw} - {10}^{- ODb}}{ADw - ADb} \cdot ( ADs - ADb ) + {10}^{- ODb} ) \qquad ( 2 )$$

Here,
ODs: Optical density at position corresponding to each pixel of detection image of coloration region,
ODb: Optical density at position corresponding to each pixel of detection image of black reference measurement plate,
ODw: Optical density at position corresponding to each pixel of detection image of white measurement plate,
ADs: Signal value of each pixel of detection image of coloration region,
ADb: Signal value of each pixel of detection image of black reference measurement plate, and
ADw: Signal value of each pixel of detection image of white reference measurement plate.

Then, the optical density of the coloring matter generated in the reaction layer 141b is determined on the basis of the image of the coloration region 141 after the correction. Next, computation processing for specifying the substance concentration of a predetermined biochemical substance in a specimen solution is carried out using lot compensation information obtained using an analytical curve that is a transform function of optical density-substance concentration (or activity) or using the reader 33.

After the termination of the measurement, the measured dry analysis element 12 is pushed out and discarded to the center side. Results of the measurement are output, the used nozzle tip 14 is removed from the spotting nozzle 45 at the tip discarding unit 9 and dropped and discarded downward, and processing is ended.

By adopting the aspect as described above, the effects of the irradiation intensity unevenness of the measuring light or the light-receiving position sensitivity unevenness of the light-receiving optical system in the colorimetry are eliminated, and it is possible to perform accurate analysis.

Although the preferred embodiment of the invention has been described, the invention is not limited to the above embodiment.

For example, only the white reference measurement plate may be provided for the reference measurement plate so as to perform correction. In that case, it is only necessary to perform the correction processing on the basis of Expression (1).

$$ODs = - Log ( \frac{{10}^{- ODw}}{ADw} \cdot ADs ) \qquad ( 1 )$$

Here,
ODs: Optical density at position corresponding to each pixel of detection image of coloration region,
ODw: Optical density at position corresponding to each pixel of detection image of reference measurement plate,
ADs: Signal value of each pixel of detection image of coloration region, and
ADw: Signal value of each pixel of detection image of reference measurement plate.

Additionally, in addition to the above, it is natural that various improvements and alterations may be performed without departing from the concept of the invention.

What is claimed is:

1. A coloration analysis device that analyzes a coloration state in a coloration region of a dry analysis element in which a coloration region is formed by laminating a supporting layer and a reaction layer, where the coloration region reacts with a test substance in a specimen solution and is colored,
the coloration analysis device comprising:
a measuring light irradiation part for irradiating the dry analysis element or a reference measurement plate having a predetermined optical density with measuring light;
an imaging part for receiving reflected light of the measuring light irradiated to the dry analysis element or the reference measurement plate, using light-receiving elements that are two-dimensionally arrayed, and for output of pixel signals indicating values of pixels that constitute an image showing the dry analysis element or the reference measurement plate;
a control part for performing the control of making the imaging part perform imaging of the coloration region of the dry analysis element irradiated with the measuring light to acquire coloration pixel signals and for performing the control of making a first reference measurement plate, which is arranged at the same position as the position of the dry analysis element with respect to the measuring light irradiation part when the coloration pixel signals are acquired, be irradiated with the measuring light to make the imaging part perform imaging to acquire the first pixel signals;
a correction part for performing correction processing for each pixel of the image of the coloration region represented by the coloration pixel signals, using values of pixels at the same positions on images, respectively, on the basis of the coloration pixel signals and the first pixel signals; and
a computing part for quantitating the test substance, on the basis of the coloration pixel signals corrected by the correction part.

2. The coloration analysis device according to claim 1,
wherein the correction part performs correction processing for each pixel of the image of the coloration region on the basis of Expression (1),
$$ODs = - Log ( \frac{{10}^{- ODw}}{ADw} \cdot ADs ) \qquad ( 1 )$$
here,
ODs: Optical density at position corresponding to each pixel of detection image of coloration region,
ODw: Optical density at position corresponding to each pixel of detection image of reference measurement plate,
ADs: Signal value of each pixel of detection image of coloration region, and
ADw: Signal value of each pixel of detection image of reference measurement plate.

3. A coloration analysis device according to claim 1,
wherein the control part makes a second reference measurement plate, which has an optical density different from that of the first reference measurement plate and is arranged at the same position as the position of the dry analysis element with respect to the measuring light irradiation part when the coloration pixel signals are acquired, be irradiated with the measuring light to make the imaging part perform imaging to acquire second pixel signals, and
wherein the correction part performs correction processing for each pixel of the image of the coloration region represented by the coloration pixel signals, using values of pixels at the same positions on images, respectively, on the basis of the coloration pixel signals, the first pixel signals, and the second pixel signals.

4. A coloration analysis device according to claim 2,
wherein the control part makes a second reference measurement plate, which has an optical density different from that of the first reference measurement plate and is arranged at the same position as the position of the dry analysis element with respect to the measuring light irradiation part when the coloration pixel signals are acquired, be irradiated with the measuring light to make the imaging part perform imaging to acquire second pixel signals, and
wherein the correction part performs correction processing for each pixel of the image of the coloration region represented by the coloration pixel signals, using values of pixels at the same positions on images, respectively, on the basis of the coloration pixel signals, the first pixel signals, and the second pixel signals.

5. The coloration analysis device according to claim 3,
wherein the correction part performs correction processing for each pixel of the image of the coloration region on the basis of Expression (2),
$$ODs = - Log ( \frac{{10}^{- ODw} - {10}^{- ODb}}{ADw - ADb} \cdot ( ADs - ADb ) + {10}^{- ODb} ) \qquad ( 2 )$$
here,
ODs: Optical density at position corresponding to each pixel of detection image of coloration region,
ODb: Optical density at position corresponding to each pixel of detection image of reference measurement plate with higher optical density,
ODw: Optical density at position corresponding to each pixel of detection image of reference measurement plate with lower optical density,
ADs: Signal value of each pixel of detection image of coloration region,
ADb: Signal value of each pixel of detection image of reference measurement plate with higher optical density, and
ADw: Signal value of each pixel of detection image of reference measurement plate with lower optical density.

6. The coloration analysis device according to claim 4,
wherein the correction part performs correction processing for each pixel of the image of the coloration region on the basis of Expression (2),
$$ODs = - Log ( \frac{{10}^{- ODw} - {10}^{- ODb}}{ADw - ADb} \cdot ( ADs - ADb ) + {10}^{- ODb} ) \qquad ( 2 )$$
here,
ODs: Optical density at position corresponding to each pixel of detection image of coloration region,
ODb: Optical density at position corresponding to each pixel of detection image of reference measurement plate with higher optical density,
ODw: Optical density at position corresponding to each pixel of detection image of reference measurement plate with lower optical density,
ADs: Signal value of each pixel of detection image of coloration region,
ADb: Signal value of each pixel of detection image of reference measurement plate with higher optical density, and
ADw: Signal value of each pixel of detection image of reference measurement plate with lower optical density.

7. The coloration analysis device according to claim 3,
wherein the optical density of a reference measurement plate with a higher optical density out of the two reference measurement plates is 1.5 or more and 2.0 or less.

8. The coloration analysis device according to claim 4,
wherein the optical density of a reference measurement plate with a higher optical density out of the two reference measurement plates is 1.5 or more and 2.0 or less.

9. The coloration analysis device according to claim 5,
wherein the optical density of a reference measurement plate with a higher optical density out of the two reference measurement plates is 1.5 or more and 2.0 or less.

10. The coloration analysis device according to claim 6,
wherein the optical density of a reference measurement plate with a higher optical density out of the two reference measurement plates is 1.5 or more and 2.0 or less.

11. The coloration analysis device according to claim 3,
wherein the optical density of a reference measurement plate with a lower optical density out of the two reference measurement plates is 0.1 or more and 0.5 or less.

12. The coloration analysis device according to claim 5,
wherein the optical density of a reference measurement plate with a lower optical density out of the two reference measurement plates is 0.1 or more and 0.5 or less.

13. The coloration analysis device according to claim 7,
wherein the optical density of a reference measurement plate with a lower optical density out of the two reference measurement plates is 0.1 or more and 0.5 or less.

14. The coloration analysis device according to claim 1,
wherein the measuring light irradiation part irradiates a predetermined irradiation region with the measuring light, and
wherein a movement part is provided to move the dry analysis element and/or the reference measurement plate to the irradiation region.

15. The coloration analysis device according to claim 2,
wherein the measuring light irradiation part irradiates a predetermined irradiation region with the measuring light, and
wherein a movement part is provided to move the dry analysis element and/or the reference measurement plate to the irradiation region.

16. The coloration analysis device according to claim 3,
wherein the measuring light irradiation part irradiates a predetermined irradiation region with the measuring light, and
wherein a movement part is provided to move the dry analysis element and/or the reference measurement plate to the irradiation region.

17. The coloration analysis device according to claim 5,
wherein the measuring light irradiation part irradiates a predetermined irradiation region with the measuring light, and
wherein a movement part is provided to move the dry analysis element and/or the reference measurement plate to the irradiation region.

18. The coloration analysis device according to claim 7,
wherein the measuring light irradiation part irradiates a predetermined irradiation region with the measuring light, and
wherein a movement part is provided to move the dry analysis element and/or the reference measurement plate to the irradiation region.

19. The coloration analysis device according to claim 11,
wherein the measuring light irradiation part irradiates a predetermined irradiation region with the measuring light, and
wherein a movement part is provided to move the dry analysis element and/or the reference measurement plate to the irradiation region.

20. The coloration analysis device according to claim 1,
wherein a light source of the measuring light irradiation part is an LED.
